(19) United States
(12) Patent Application Publication
(10) Pub. No.: US 2026/0162553 A1
(43) Pub. Date: Jun. 11, 2026

(54) BIDIRECTIONAL, MULTIMODAL EXAMINER FOR DYNAMIC, PERSONALIZED QUESTION AND ANSWER PRACTICE

(71) Applicant: Call Simulator, Tallahassee, FL (US)

(72) Inventors: Luke Van Popering, Washington, DC (US); Eric Sharkey, Nashville, TN (US); Jeremy Quinto, Tallahassee, FL (US); Michael LaFortune, Satellite Beach, FL (US); David Lawson, Tallahassee, FL (US)

(73) Assignee: Call Simulator, Tallahassee, FL (US)

(21) Appl. No.: 19/392,278

(22) Filed: Nov. 18, 2025

Related U.S. Application Data
(60) Provisional application No. 63/728,381, filed on Dec. 5, 2024.

(51) Int. Cl. G09B 7/00; G06T 13/40

(52) U.S. Cl. CPC G09B 7/00; G06T 13/40

(57) ABSTRACT

The present invention comprises novel processes to facilitate learning through automated, bidirectional, multimodal, and personalized question and answer practice. Content creation is accelerated through an automated extraction pipeline, lowering barrier-to-entry in domains with sufficient documentation. To practice the material, Learners converse with an AI Examiner which offers personalized, dynamic follow-up responses and evaluation. The Examiner may assume the role of an instructor or a student, either posing questions or attempting to answer them, with the Learner adopting the opposite role. Other configuration settings for the Examiner include input/output modality and grading stringency. With these options available, a Learner can rapidly iterate through different postures and means of practice and learning, compressing the time required to master knowledge and related question and answer skills. Learners gain question and answer skills while deepening their knowledge, familiarity, and fluency with terminology and domain information.

### FIELD OF THE INVENTION

The present invention relates to novel technology and processes to support human learning through automated, bidirectional, multimodal, and personalized question and answer practice.

### BACKGROUND OF THE INVENTION

Understanding domain-specific requirements, best practices, and terminology (e.g., employee handbooks, vertical industry language, text of regulations, etc.) and being able to reference them appropriately in conversation is critical in many professional settings. When it comes to acquiring this knowledge, or allowing those who already possess it the opportunity to practice, the gold-standard is a classroom or one-on-one interaction with a qualified human instructor. However, as instructors are costly, organizations often settle for static reading, flashcard, video, and quiz-taking content, which are limited in how well they can adapt to any Learner's particular needs.

To supplement the (small or non-existent) pool of human instructors, AI technologies such as Large Language Models are being used to deliver automated, real-time feedback downstream of live interactions. Customer support and sales have been early adopters; support calls that were once manually reviewed by an instructor are now frequently done so by an LLM agent. Although these systems are highly scalable, their reliance on live interactions makes them ill-suited to general-purpose learning and development. This is because:
i. Live interactions are unpredictable. Whether any subject, let alone one which a Learner struggles with, surfaces during a live interaction is random, and without the ability to target specific material, it is difficult to design effective curricula.
ii. Live interactions involve risk. If a Learner performs poorly during an interaction, which may be a frequent occurrence among new hires or trainees, that can have broader repercussions and lead to a negative career outcome. Learning should occur in a consequence-light environment; the ideal penalty for failure is nothing more than additional, mandated practice.
iii. Outside of customer-facing positions, live interactions may either not exist or rarely be recorded; e.g., a civil engineer does not transcribe their commentary while on a job site.

### SUMMARY OF THE INVENTION

The present invention encompasses systems for i. constructing courses and quizzes from a reference corpus, such as textbooks, regulations, etc.; and ii. practicing this material in a safe, consistent environment via dialogue with an “AI Examiner.” Each course or quiz ultimately consists of organized {question, answer, subanswers} tuples. Context and examples may be added to further inform the Examiner's behavior.

There are multiple configuration options available for the Examiner. Behavioral preferences, biographic information, role, and level of difficulty, among other details, comprise an Examiner's “persona.” Learners may choose to interact with the Examiner through text, voice, or video. Voice modality supports background noise and multiple languages and dialects, and video modality synchronizes the audio track to a life-like virtual avatar.

The Examiner is bidirectional, as it can assume the role of either an instructor or a student. When acting as an instructor, the Examiner will provide personalized, contextually dependent follow-ups in response to each of the Learner's statements and guide them through the material. When acting as a student, the Examiner instead responds to follow-ups posed by the Learner, who now assumes the instructor role. This can complement an instructor-mode Examiner, offering Learners an orthogonal means to test their knowledge, or be deployed alone to accelerate the training of human instructors. A student-mode Examiner may rotate between multiple personas, mimicking a classroom environment with students of varying levels of proficiency.

### BRIEF DESCRIPTION OF DRAWINGS

FIG. 1 depicts the high-level processes for content creation and iterative refinement thereof. QASes, complete with context and examples, quizzes, and courses are extracted from provided reference documentation. Administrators then engage in an ongoing review process, making adjustments to the content in light of both their observations of the AI Examiner and those of Learners. In doing so, they generate high-quality labels that can be used to further optimize the underlying extraction models.

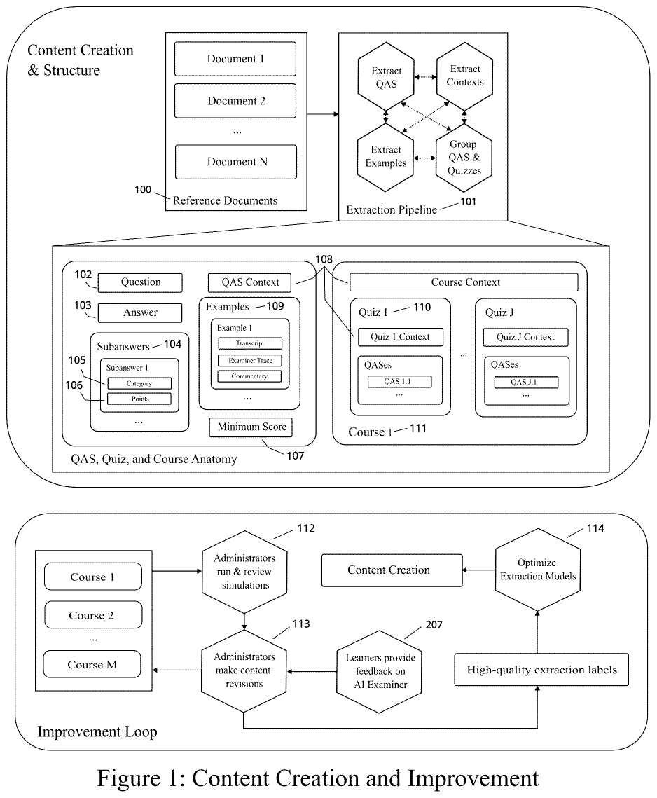

FIG. 2 shows the logical flow of a simulation. Each simulation consists of a back-and-forth conversation between AI Examiner and Learner wherein the Learner's statements are assessed against subanswers and the Examiner responds with in-context follow-ups. The Examiner's behavior is contingent upon its configuration settings and, if desired, the Learner's simulation history and/or that of others. Once a simulation is complete, the Examiner returns various numeric metrics in addition to a coaching summary. Learners may provide feedback on particular scoring or follow-up decisions; this feedback enables continual optimization of the Examiner.

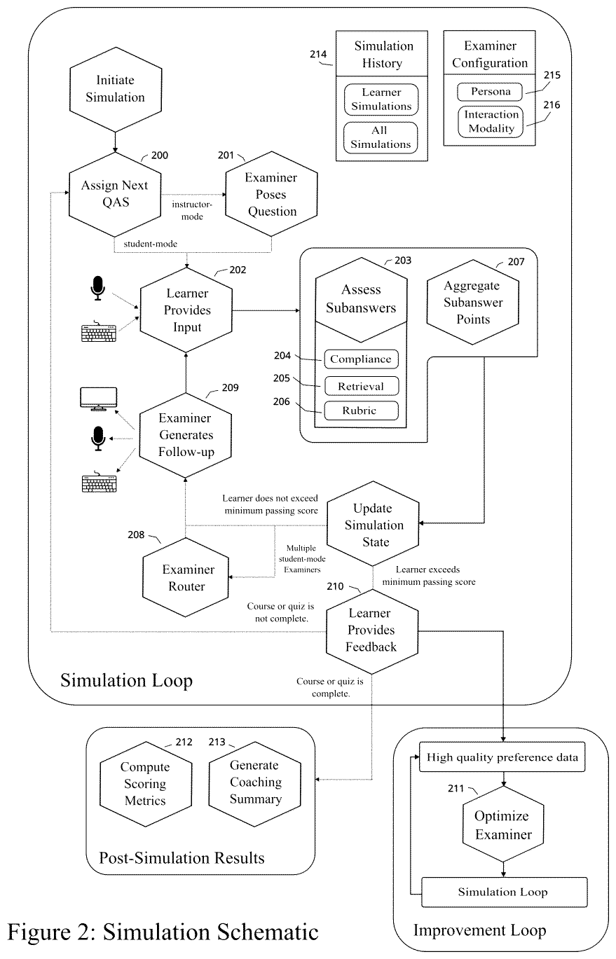

### DETAILED DESCRIPTION OF THE INVENTION

Refer to each continuous interaction with the AI Examiner(s) as a “simulation.” Prior to commencing a simulation, a Learner may adjust various configuration settings or select from presets created by an administrator. These encompass:
i. The AI Examiner's persona(s) 215, including but not limited to:
   a. biographic details, such as age, gender, or language and dialect.
   b. role, being whether it is acting in instructor-mode or student-mode.
   c. proxies for simulation difficulty; e.g., how stringent the Examiner will be in scoring the Learner, how likely they are to provide hints if the Learner is struggling, their grasp of the material, especially if acting as a student; etc.
   d. other behavioral specifications, such as writing style or emotional state.
   e. optionally, a voice and/or a 2D or 3D avatar representation of the Examiner.
ii. Interaction modality 216, being text, voice, or video. For voice interaction, the Examiner's persona must specify a voice, and video interaction additionally requires an avatar. Multiple background noise options are available to choose from vis a vis location, volume, and noise level.

Simulations may be run with multiple student-mode Examiners; however, there cannot be more than one instructor-mode Examiner, and mixed modes are not permitted. This document assumes a single Examiner as default. Unless otherwise noted, all statements apply equally regardless of the number of Examiners.

The smallest unit of content which the AI Examiner understands is {question, answer, subanswers} tuples, or QASes. Questions 102 define subject matter and, if the Examiner is operating in instructor-mode, are posed verbatim to the Learner. They need not be questions in a strict sense: “Describe X” is equally as valid as “What is X?”. Answers 103, meanwhile, illustrate one possible way in which the Learner could succeed at a QAS, being closer to a “textbook answer” than a singular answer. Finally, subanswers 104 parameterize the space of correct responses. They facilitate detailed evaluation of the Learner or a student-mode Examiner and are assigned to one of three categories 105 depending on the behavior assessed. In order of increasing complexity,
i. Compliance Subanswers 204 require the Learner or a student-mode Examiner to provide certain information verbatim. They are most appropriate when the question asks for a prepared statement (e.g., a disclaimer to limit liability) that one must memorize and later repeat as part of their professional responsibilities.
ii. Retrieval Subanswers 205 require the Learner or a student-mode Examiner to communicate a concept(s). Compared to compliance subanswers, these evaluate content, not verbiage, and thus permit more open-ended responses. If a question possesses a relatively limited number of acceptable responses, as is most often the case, then it will be well-suited to retrieval subanswers.
iii. Rubric Subanswers 206 require the Learner or a student-mode Examiner to exhibit an abstract behavior(s). Questions which explicitly ask for an example or justification, possess a substantial number of acceptable responses, too many to enumerate as retrieval subanswers, or focus on elements of the one's thought process are ideal cases for rubric subanswers.

Once a subanswer is satisfied, it will award an adjustable number of points 106 to the Learner. When the Examiner is operating in instructor-mode, points indicate how well the Learner has addressed the subanswers through their responses to the Examiner; in student-mode, they reflect the extent to which the Examiner has addressed the subanswers as a result of the Learner's probing. The Learner succeeds at a QAS if their accumulated points exceed its minimum passing score 107, also adjustable.

Define a “quiz” 110 to be a collection of one or more QASes and a “course” 111 to be a hierarchical grouping of quizzes. In addition to manual creation by an administrator, new QASes, quizzes, and courses may be extracted 101 from an appropriate reference corpus (e.g., FAA regulations in the aviation domain, employee handbooks for customer service, etc.) 100. It is possible to condition the extraction process so as to, among other things, produce answers and subanswers for a predetermined set of questions, ensure that particular QASes are included in the same quiz, or dictate overall course structure.

If deemed necessary, QASes, quizzes, and courses can be augmented with:
i. Context passages 105, which contain either domain knowledge, deepening the Examiner's understanding of a topic, or explicit instructions, such as to avoid a problematic follow-up. Context passages are assigned to a QAS, quiz, or course, and are hierarchical. So, if the Learner is simulating a course, the context presented to the Examiner will be a combination of the course context, context of the current quiz, and context of the current QAS. Context passages may be created manually or generated during extraction.
ii. Example simulations 106, which each consist of a simulation transcript, a record of the Examiner's decisions and reasoning, and commentary regarding what did or did not go well. An example illustrates how the Examiner ought to behave under known circumstances. Examples may be created manually, copied from existing simulations, or generated during extraction; and they only exist at the level of individual QASes.

Administrators may also associate arbitrary metadata tags to a QAS, quiz, or course. These are used for search and for filtering a Learner's performance metrics.

Quizzes, courses, QASes, etc. are honed through an iterative review process. Administrators—who are, ideally, qualified human instructors-continually review Learner simulations and run simulations themselves 112, determine if and how the Examiner's behavior differs from what is desired, and make appropriate revisions to content 113. The end result is a “virtuous cycle”: each revision creates a new ground-truth label which can be used to further improve automated extraction 114. If, for instance, the extraction pipeline leverages LLMs, this might entail supervised fine-tuning or, with less data, Automatic Prompt Optimization.

Simulations are run in either instructor-mode or student-mode depending on the AI Examiner configuration. When acting as an instructor, the Examiner begins by stating the question from the selected QAS (or the first one in the quiz or course) 201, which a Learner must then answer to the best of their ability. A student-mode Examiner instead waits for the Learner to initiate the conversation.

Voice and video inputs are handled via Speech-to-Text transcription with biasing towards domain-specific, infrequent terminology. After the Examiner detects a response from the Learner, if operating in instructor-mode, or responds to the Learner, if operating in student-mode, it scores their interactions thus far against the subanswers 204, accounting for context, examples, etc.; and awards the appropriate quantity of points 207. Scoring is influenced by the Examiner's persona; it may be varying degrees of exacting, broadly or for specific subanswers, depending on the specification. If the Learner accumulates sufficient points to succeed at the current QAS, the simulation either terminates, if only running a single QAS, or resets the Learner's points and transitions to the next QAS in the quiz or course 200.

If a simulation involves multiple student-mode Examiners, then each Examiner will separately score and track points, and the Learner will only succeed once all Examiners have awarded sufficient points.

Until the Learner succeeds (or hits an adjustable maximum turn count), the Examiner will generate follow-up responses 209 conditioned, at minimum, on the current simulation, available context and examples, subanswer scoring, and the Examiner persona. This produces an extended back-and-forth conversation that mimics interaction with a human instructor. For an Examiner in instructor-mode, follow-ups guide the Learner towards addressing any remaining subanswers and correcting their mistakes. For an Examiner in student-mode, the roles are reversed: follow-ups now consist of the Examiner's continued attempts to address the subanswers with guidance from the Learner.

In both instructor-mode and student-mode, the Examiner's persona influences the tone and writing style of follow-ups; e.g., an Examiner defined to be curt or impatient will respond with briefer follow-ups and employ more aggressive, blunt language. Similarly, specifying a poor understanding of the material in the persona biases the Examiner towards incorrect or incomplete follow-ups and the opposite for a strong understanding.

Optionally, follow-ups may be conditioned on Learners' prior attempts at a QAS, quiz, or course, or even those of other Learners 214. The Examiner can leverage this additional context to better adapt to each Learner's proficiency, such as by deemphasizing or even automatically awarding points for subanswers which a Learner has repeatedly addressed in past simulations.

With multiple student-mode Examiners, a router selects the most appropriate from among those which have yet to award sufficient points to the Learner 208, and only that Examiner delivers a follow-up response. This follow-up is visible to all Examiners—they share simulation history—but is tagged to identify which Examiner it originated from.

For voice and video modalities, follow-up responses are spoken in the Examiner's voice via Text-to-Speech; additionally, for video, the audio track will be synchronized to the Examiner's virtual avatar.

Learners may dispute each scoring decision or follow-up response, leaving written feedback 210 to indicate how precisely the Examiner erred. This feedback further informs administrators during their content review process. It also creates another virtuous cycle, wherein various techniques from the literature, namely preference learning, can be employed to update the Examiner's underlying model 211 and improve the accuracy of subanswer scoring and quality of follow-ups. If follow-ups are conditioned on prior simulations, any Learner feedback will be included.

At termination, simulation results are collated into a report consisting of a coaching summary 213 and various numeric metrics 212 (e.g., percentage of QASes correct, average number of follow-ups, etc.). The coaching summary offers a review of the entire simulation and identifies a Learner's strengths and weaknesses. It is delivered in the same modality (text, voice, video) as the simulation, though it may be configured separately from the Examiner. Metrics can be aggregated at the course, quiz, or QAS-level, as applicable, via metadata tags, or per-Examiner if there were multiple present within the simulation.

1. A process for loading, creating, and tuning content for use in automated, conversational teaching and learning device comprising systems for:
AI generation or manual creation and revision of question, answer, and subanswer(s), including category and point value; and
AI generation or manual creation and revision of quizzes, being flat collections of questions, answers, and subanswers; and courses, being hierarchical collections of quizzes; and
AI generation or manual creation and revision of context to provide background information and instruction; and
AI generation or manual creation and revision of example simulations, consisting of a simulation transcript, AI Examiner record, and commentary; and
associating metadata tags with quizzes and courses;
wherein, the content to be practiced is represented and given context in the device of claim 1.

2. An automated, conversational teaching and learning system for personalized practice of domain knowledge and skills comprising:
a bidirectional, multimodal AI Examiner allowing a Learner to practice:
answering questions posed by an Examiner that is acting as an instructor; and
questioning and following-up on answers provided by:
an Examiner that is acting as a student; and
multiple Examiners that are acting as students; and
configuration options for the AI Examiner, consisting of:
language and spoken voice and accent or written dialect; and
virtual avatar 2D or 3D video representation; and
biographic details, such as gender or age, and
behavioral specifications affecting difficulty and fluency, such as writing style, level of domain mastery, or stringency; and
configurable background sounds for voice or video practice, emulating:
variable sound contexts, such as simulated locations; and
variable sound volume; and
variable signal to noise for the AI Examiner, such as clear speech in quiet environment or quiet speech in loud environment; and
role, being either that of:
an instructor helping a Learner improve their knowledge by having the Learner answer questions and follow-ups posed by the AI Examiner; or
a student helping a Learner improve their skills and knowledge by having the AI Examiner answer questions and follow-ups posed by the Learner; and
scoring of Learner statements conditioned upon:
context passages as in claim 1; and
example simulations as in claim 1; and
subanswers, including category and point value; as in claim 1 and
AI Examiner configuration, affecting stringency; and
dynamic follow-up response generation based upon:
the input of the Learner, such as the Learner's response to a question posed by an instructor-mode AI Examiner or the Learner's question to a student-mode AI Examiner; and
the AI Examiner configuration, affecting the word choice and speech elements, and
depth and tone of follow-up responses; and
behavioral and labeling data, including prior simulations and process feedback from Learners; and
scoring for the present simulation; and
context passages as in claim 1; and
example simulations as in claim 1; and
generated coaching statements following simulation derived from:
scoring for the present simulation; and
context passages as in claim 1; and
aggregate numeric metrics derived from:
scoring for the present simulation; and
metadata tags as in claim 1; and
Learner labeling of and feedback on:
scoring for the present simulation; and
follow-up responses provided by the AI Examiner;
wherein, the device and application is delivered over web, mobile, telephony, API, interactive communication devices, embodied AI, robotics, or machine-based interfaces.

3. Consumption device and/or application to deliver claim 1 and claim 2; comprising:
device and/or application for loading, organizing, and tuning content; and
device and/or application for delivering bidirectional practice;
wherein, the device and application is delivered over web, mobile, telephony, API, interactive communication devices, embodied AI, robotics, or machine-based interfaces.

4. System to produce combinations of bidirectional synthetic and human assessment, expert, and behavioral data for AI model and system creation and tuning in education contexts, comprising:
outputs and inputs from claim 1, such as expert knowledge and content administrator-approved subanswers, context, and examples; representing forms of knowledge and means to assess mastery by a Learner; and
outputs from claim 2, such as Learner inputs, follow-ups from AI Examiner student or instructor personas, scoring results, and behavioral and labeling data; as an accumulation of Learner and AI Examiner behavior;
wherein, the application of data aggregated from claims 1 and 2 into the claim 3 consumption device for use in creating and improving upon the AI Examiner and other models and systems relevant to the invention.
